(19) United States
(12) Patent Application Publication
(10) Pub. No.: US 2004/0075977 A1
(43) Pub. Date: Apr. 22, 2004

(54) USB memory receptacle of electronic device

(76) Inventor: Kuo-Shao Lee, Taipei (TW)

Correspondence Address: SUPREME PATENT SERVICES, POST OFFICE BOX 2339, SARATOGA, CA, 95070, US

(21) Appl. No.: 10/278,607

(22) Filed: Oct. 22, 2002

(51) Int. Cl. G06F 1/16

(52) U.S. Cl. 361/684

(57) ABSTRACT

An electronic device, such as a notebook computer, includes a casing having walls defining an interior space in which a USB socket is mounted. A receptacle is defined in the casing for receiving a USB memory device that comprises a housing having a front end to which a USB plug is mounted and an opposite rear end. The receptacle includes a chamber formed inside the casing of the electronic device and in communication with the USB socket and an opening defined in one of the walls of the casing of the electronic device and in communication with the chamber for the entry of the USB memory device into the chamber. The chamber is sized and shaped corresponding to the housing of the USB memory device for completely receiving the USB memory device therein with the USB plug of the USB memory device engaging the USB socket of the electronic device whereby the rear end of the USB memory device is substantially flush with the wall of the casing for maintaining the surface integration of the casing of the electronic device. The opening that is defined in the wall of the casing has opposite side edges in which notches are defined for accommodating a user's fingers for gripping and removing the USB memory device from the electronic device.

### FIELD OF THE INVENTION

The present invention relates generally to the field of electronic devices having a universal serial bus (USB) port for engaging an external USB device, and in particular to a USB receptacle defined in an electronic device, such as a notebook computer for receiving and engaging a removable and portable USB memory device.

### BACKGROUND OF THE INVENTION

Electronic devices, such as notebook computers, comprise built-in memory for storage of for example operation system of the electronic device. Besides the built-in memory, the notebook computers are also provided with external memory for expansion of memory storage capacity. Some external memory devices are made removable for readily mounting to and/or dismounting from the computer. Examples of such external memory devices are illustrated in U.S. Pat. Nos. 4,532,564 and 4,608,617. However, these known memory devices are magnetic recording media, which have large sizes and require long access times. In addition, the removable structure of these external memory devices is for enhancement of assemblage and maintenance, rather than providing portability of the memory devices. In other words, these conventional external memory devices are not designed to frequently switch between different computers for transfer of data.

A type III PCMCIA card allows for removal of a hard disk drive from a notebook computer having a PCMCIA connector. However, since such an external memory device, although functioning as a portable or removable external memory device, is a magnetic recording memory that requires long access time in operation.

A universal serial bus (USB) memory device, which is embodied in the form of a card or a stick having a USB plug formed on one end, is an alternative external memory device that has short access time. The USB memory device is often connected to a computer by plugging the USB plug of the USB memory device into a USB socket mounted in the computer. Since the USB socket is provided for connection with USB based peripheral devices, such as printer, scanner, keyboard, mouse, joystick and even digital camera, the USB socket is clearly exposed and readily accessed by a computer user for ready connection/disconnection of the peripheral devices to/from the computer. As a consequence, the USB plug of the peripheral device is located outside the computer casing. This is the same for the USB memory device. Thus, the USB memory device is located outside the computer casing when it is connected to the computer. The surface integration of the computer casing cannot be maintained because the USB memory device protrudes outside the casing.

FIG. 3 of the attached drawings shows a USB memory device, generally designated with reference numeral 100, is connected to a desktop computer 102. The desktop computer 102 comprises a USB socket or USB port 104 into which a USB plug 106 of the USB memory device 100 is plugged to mechanically and electrically connect the USB memory device 100 to the computer 102. The memory device 100 is completely located outside the computer, resulting in deterioration of surface integration of the computer. This is an even serious problem in a notebook computer, which has a much smaller and more compact configuration as compared to the desktop computer.

### SUMMARY OF THE INVENTION

Thus, an object of the present invention is to provide a receptacle formed in a computer casing for receiving an external memory device in such a way to maintain the surface integration of the computer casing while allowing for user's ready access to the memory device.

Another object of the present invention is to provide a receptacle formed in a computer casing for receiving an external memory device wherein the surface integration of the computer casing is maintained while quick access of the memory device by the computer is enhanced.

To achieve the above objects, in accordance with the present invention, there is provided a receptacle inside the casing of an electronic device, such as a notebook computer. The casing of the electronic device defines an interior space in which a USB socket is mounted. The receptacle is defined in the casing of the electronic device for receiving a USB memory device that comprises a housing having a front end to which a USB plug is mounted and an opposite rear end. The receptacle includes a chamber formed inside the casing of the electronic device and in communication with the USB socket and an opening defined in one of the walls of the casing of the electronic device and in communication with the chamber for the entry of the USB memory device into the chamber. The chamber is sized and shaped corresponding to the housing of the USB memory device for completely receiving the USB memory device therein with the USB plug of the USB memory device engaging the USB socket of the electronic device whereby the rear end of the USB memory device is substantially flush with the wall of the casing for maintaining the surface integration of the casing of the electronic device. The opening that is defined in the wall of the casing has opposite side edges in which notches are defined for accommodating a user's fingers for gripping and removing the USB memory device from the electronic device.

### BRIEF DESCRIPTION OF THE DRAWINGS

The present invention will be apparent to those skilled in the art by reading the following description of a preferred embodiment thereof, with reference to the attached drawings, in which:

FIG. 1 is a perspective view of a notebook computer having a casing in which a memory receptacle constructed in accordance with the present invention is defined for receiving a USB memory device;

FIG. 2 is another perspective view of the notebook computer with the USB memory device received in the memory receptacle thereof; and

FIG. 3 is a perspective view of a desktop computer having a conventional USB socket to which a USB memory device is mounted.

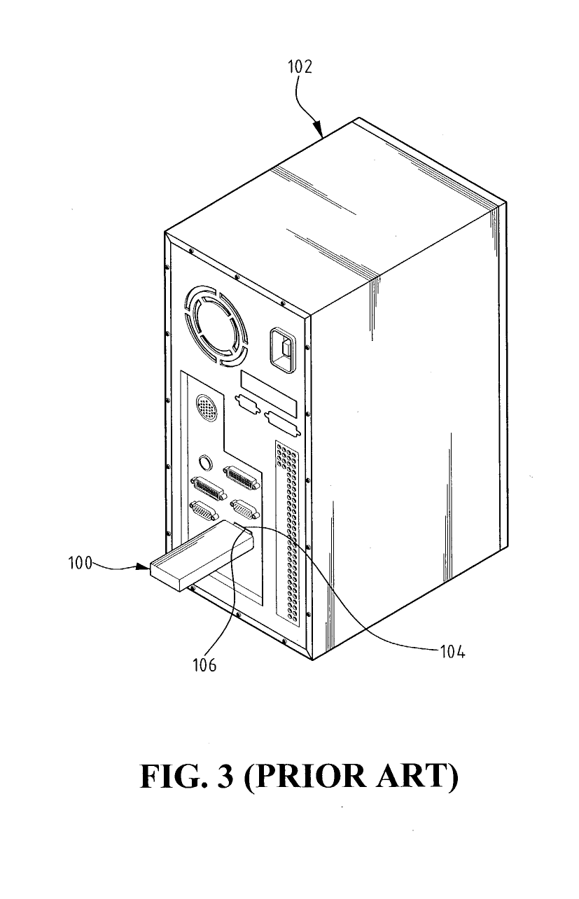

### DETAILED DESCRIPTION OF THE INVENTION

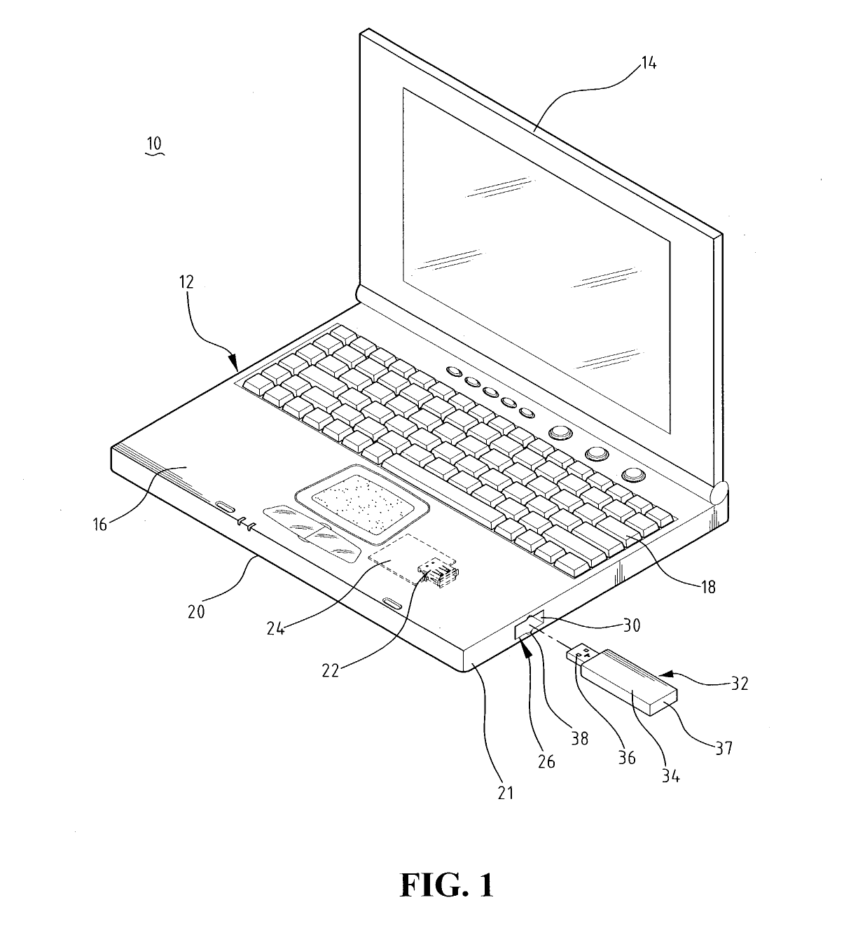

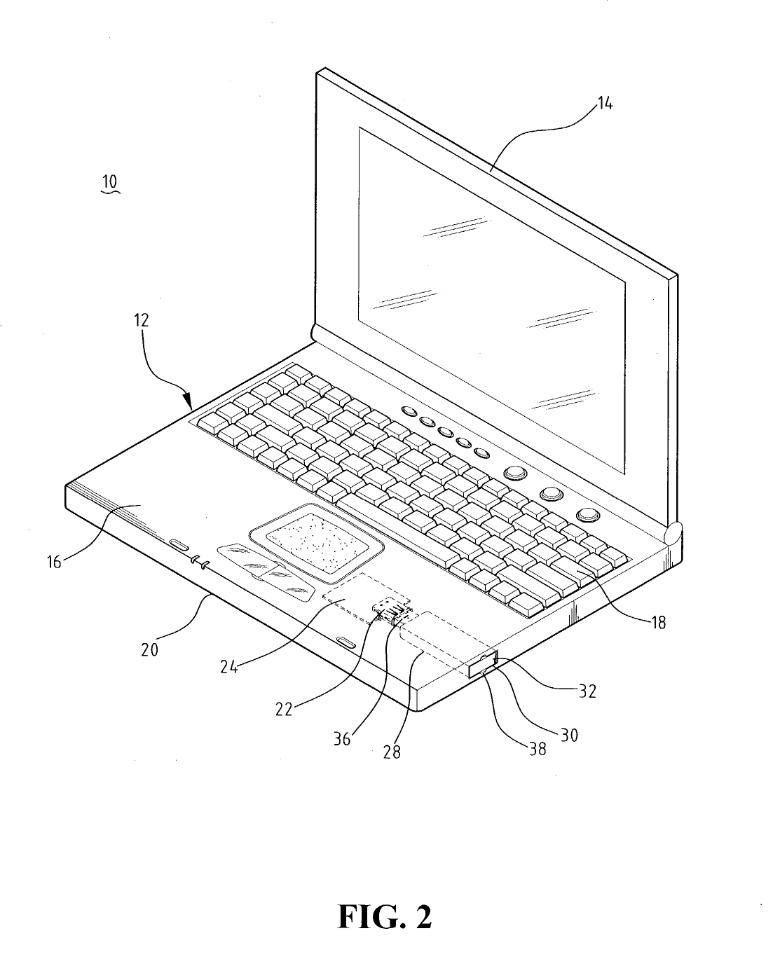

With reference to the drawings and in particular to FIGS. 1 and 2, a notebook computer, generally designated with reference numeral 10, comprises a casing 12 to which a display panel 14 is pivoted. The casing 12 has a top wall 16 to which a keyboard 18 is mounted and an opposite bottom wall 20 positionable on a support surface (not shown), such as a desk surface. The casing 12 further comprises side walls 21 connected between the top and bottom walls 16, 20 and defines an interior space (not labeled) therebetween. A USB socket 22 is mounted to a circuit board 24 within the interior space of the casing 12. The USB socket 22 is of regular standards and is thus engageable with a standard USB plug. The circuit board 24 of the USB socket 22 is electrically connected to a main board (not shown) of the computer 10 whereby signals received through the USB socket 22 is eventually transferred to or applied to the main board.

The casing 12 defines a receptacle 26. The receptacle 26 can be defined at any suitable position in the casing 12, such as and as illustrated in the drawings, in one of the side walls 21. The receptacle 26 comprises a chamber 28 formed inside the casing 12 and an opening 30 defined in the side wall 21 and in communication with the chamber 28. The chamber 28 is in communication with the USB socket 22 inside the casing 12 and is sized and shaped to completely receive a USB memory device 32 therein with the USB memory device 32 entering through the opening 30.

The USB memory device 32 comprises a housing 34 inside which memory means (not shown) is mounted. A USB plug 36 is formed on a front end (not labeled) of the housing 34 and is electrically connected to the memory means inside the housing 34. The chamber 28 of the USB receptacle 26 has a size and shape substantially corresponding to the housing 34 of the USB memory device 32 so as to completely and substantially snugly receive the USB memory device 32 therein with the USB plug 36 fit into and electrically engaging the USB socket 22 of the computer 10. Thus, when the USB memory device 32 is fit into the USB receptacle 26 of the computer 10, a rear end 37 of the housing 34 of the USB memory device 32 is substantially flush with the side wall 21 of the computer casing 12. This maintains the surface integration of the computer casing 12.

The opening 30 of the USB receptacle 26 that is defined in the side wall 21 of the computer casing 12 has opposite side edges (not labeled) in which aligned notches 38 are defined. The notches 38 provide spaces for accommodating fingers (not shown) of a computer user whereby the computer user may grip the USB memory device 32 with his or her fingers positioned into the notches 38. This allows the user to remove the USB memory device 32 from the receptacle 26 of the computer 10.

Although the present invention has been described with reference to the preferred embodiment thereof, it is apparent to those skilled in the art that a variety of modifications and changes may be made without departing from the scope of the present invention which is intended to be defined by the appended claims.

What is claimed is:

1. In an electronic device comprising a casing having walls defining an interior space in which a USB socket is mounted, a receptacle for receiving a USB memory device that comprises a housing having a front end to which a USB plug is mounted and an opposite rear end, the receptacle comprising:
a chamber formed inside the casing and in communication with the USB socket; and
an opening defined in one of the walls of the casing of the electronic device and in communication with the chamber for entry of the USB memory device into the chamber;
wherein the chamber is sized and shaped corresponding to the housing of the memory device for completely receiving the housing of the USB memory device therein with the USB plug of the USB memory device engaging the USB socket of the electronic device; and
wherein the opening has opposite side edges in which notches are defined for accommodating fingers for gripping and removing the USB memory device from the electronic device.

2. The electronic device as claimed in claim 1, wherein the electronic device comprises a notebook computer.

3. The electronic device as claimed in claim 1, wherein the rear end of the USB memory device is substantially flush with the wall of the casing of the electronic device when the USB memory device is fit into the receptacle.

4. The electronic device as claimed in claim 1, wherein the notches are substantially aligned with each other.
